(19) United States
(12) Patent Application Publication
(10) Pub. No.: US 2026/0242600 A1
(43) Pub. Date: Aug. 20, 2026

(54) ADDITION-CURE SILICONE RUBBER

(71) Applicant: Momentive Performance Materials Inc., Niskayuna, NY (US)

(72) Inventors: Huiping ZHANG, Clifton Park, NY (US); Rabon VINCENT, JR., Kendallville, IN (US); Robert RUDOLPH, Ft. Wayne, IN (US); James Edward KELLEY, Fremont, IN (US); Beate GANTER, Monheim (DE); Vincent Joseph COLAROSSI, Melrose, NY (US)

(21) Appl. No.: 18/992,794

(22) PCT Filed: Jul. 12, 2023
(86) PCT No.: PCT/US2023/027473

§ 371 Date: Jan. 9, 2025

Related U.S. Application Data
(60) Provisional application No. 63/388,428, filed on Jul. 12, 2022.

(51) Int. Cl. C08L 83/06; B01J 23/42; C08F 4/80; C08K 5/05; C08K 9/06; F16J 15/3284

(52) U.S. Cl. CPC C08L 83/06; B01J 23/42; C08F 4/80; C08K 5/05; C08K 9/06; F16J 15/3284; C08K 2201/006; C08L 2203/02; C08L 2205/025

(57) ABSTRACT

An addition-cure silicone rubber composition is shown and described herein. In one aspect, the addition-cure silicone rubber composition provides a cured silicone rubber that has negligible crystallization, evidenced by a low softening point temperature, and is substantially free of bubbles. In one aspect, provided is an addition-cure silicone rubber composition comprises (i) an alkenyl-functional siloxane that include aryl-functional siloxane units; (ii) a polyorganohydrogen siloxane; (iii) a hydrogen siloxane having six or fewer siloxane units; and (iii) a silylated silica filler. By controlling the amount of the aryl-functional siloxane units, the amount of hydrogen siloxane with six or fewer siloxane units, and the degree of functionalization of the silica filler, a cured rubber material can be formed that exhibits excellent elastomeric properties at extremely low temperatures and can also be relative free of bubbles to ensure good aesthetics and adequate mechanical properties of cured articles.

### CROSS-REFERENCE TO RELATED APPLICATIONS

The present application claims priority to and the benefit of U.S. Provisional Patent Application No. 63/388,428 titled Addition-Cure Silicone Rubber filed on Jul. 12, 2022, the entire disclosure of which is incorporated herein by reference in its entirety.

### FIELD OF INVENTION

The present invention relates to an addition-cure silicone rubber composition, a cured silicone rubber formed from such a composition, and an article formed from such a composition. In particular, the present invention relates to an addition-cure silicone rubber composition that, when cured, forms a silicone rubber that exhibits excellent physical properties, e.g., flexibility at low temperatures, even temperatures below −100° C., and a high degree of light transmittance.

### BACKGROUND

Silicone rubber materials are used in a variety of applications. They may be used, for example, to form conduits to retain or transport fluids. In some industries, articles housing the fluids may need to be kept at extremely low temperatures during transport and/or prior to use of the fluid. One example is in the pharmaceutical industry, where pharmaceutical materials need to be stored at extremely low temperatures in the range of from below −30° C. to below −100° C. Aeronautical vehicles may include rubber materials, e.g., o-rings, gaskets, hoses, tubing, etc., that may be subject to extreme variations in temperature and extremely low temperatures. Conventional silicone rubbers, however, typically lose flexibility when the temperature drops below −40° C. This may result in the article becoming rigid or cracking when subject to extremely low temperatures.

Extrusion of silicone rubber tubing demands fast cure and absence of out-gassing. While some peroxide-cure silicone compositions may produce rubbers with good elastomeric properties at low temperatures, peroxide-cure rubbers cure more slowly than addition-cure rubbers and are not suitable in many applications such as tubing extrusion. In addition, peroxide-curing typically requires additional processing steps to remove peroxides from the system. Residual peroxides in the system can produce toxic byproducts, unwanted crosslinking, and out-gassing.

On the other hand, addition-cure rubber silicones may experience out-gassing issues during tubing extrusion caused by the dehydrogenative condensation reaction between the low volatile reactive silicone hydride and absorbed moisture. Out-gassing that occurs during vulcanization can lead to bubble formation, which not only affects aesthetics of the tubing but may also affect the mechanical properties of the tubing.

Many industries employ articles that are transparent so as to be able to see the contents of the articles or observe the flow of a fluid through the article. Conventional polydimethylsiloxane-based rubber are generally translucent due to slight mismatch of refractive index between polydimethylsiloxane and silica filler and thereby may not fit applications that require high clarity and low haze.

### SUMMARY

The following presents a summary of this disclosure to provide a basic understanding of some aspects. This summary is intended to neither identify key or critical elements nor define any limitations of embodiments or claims. Furthermore, this summary may provide a simplified overview of some aspects that may be described in greater detail in other portions of this disclosure. Provided is an addition-cure silicone rubber composition. The silicone rubber composition provides a cured silicone rubber exhibiting low crystallization and low bubble content. In embodiments, a cured silicone rubber formed from the composition has a softening temperature down to −110° C. In embodiments, a cured silicone rubber formed from the composition has a softening temperature down to −115° C. In embodiments, a cured silicone rubber formed from the composition is substantially free of any bubbles. In embodiments, a cured silicone rubber formed from the composition is free of bubbles.

In one aspect, provided is an addition-cure silicone rubber composition comprising (A) an alkenyl-functional siloxane comprising aryl-functional siloxane units; and (B) a polyhydrogensiloxane; wherein the silicone rubber composition in the cured state has a softening temperature down to −110° C. using DSC; and/or wherein the cured silicone rubber is substantially free of bubbles.

In one aspect, provided is an addition-cure silicone rubber composition comprising (i) an alkenyl-functional organopolysiloxane that includes aryl-functional siloxane units, (ii) a polyorganohydrogen siloxane, (iii) a hydrogen siloxane having six or fewer siloxane units, and (iv) a silylated silica filler.

In one aspect, provided is an addition-cure silicone rubber composition comprising: (A) an alkenyl-functional siloxane comprising aryl-functional siloxane units in an amount of from about 4.8 mol % to about 13 mol %; (B) a polyhydrogensiloxane; (C) an organohydrogen siloxane different from the polyhydrogensiloxane (B), the organohydrogen siloxane (C) having six or fewer siloxane units, wherein the organohydrogen siloxane (C) is present in an amount of from 0.01 wt. % to 0.8 wt. % of the total weight amount of (B) and (C); (D) a hydrosilylation catalyst; (E) a surface modified silica; (F) optionally an inhibitor; and (G) optionally an auxiliary additive.

In one embodiment, the surface modified silica has at least three different types of silylating agents.

In one embodiment, the surface modified silica is modified with both a silane and a siloxane.

In one embodiment, the surface modified silica is modified with a silane, a siloxane, and a silazane.

In one embodiment in accordance with any previous embodiment, the surface modified silica has at least 40 mol % of surface silanols modified with a functional group.

In one embodiment in accordance with any previous embodiment, 45 mol % to 85 mol % of surface silanols of the surface modified silica are modified with a functional group.

In one embodiment in accordance with any previous embodiment, the alkenyl-functional siloxane (A) has from about 5 mol % to about 10 mol % of aryl-functional siloxane units.

In one embodiment in accordance with any previous embodiment, the organohydrogen siloxane (C) is present in an amount of from 0.05 wt. % to 0.6 wt. % of the total weight amount of (B) and (C).

In one embodiment in accordance with any previous embodiment, the organohydrogen siloxane (C) is present in an amount of from 0.1 wt. % to 0.5 wt. % of the total amount of (B) and (C).

In one embodiment in accordance with any previous embodiment, the alkenyl-functional siloxane is of the formula (I):

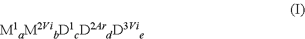

where:
M¹ is (R¹)₃SiO_{1/2}
M^{2Vi} is (R²)(R³)₂SiO_{1/2}
D¹ is (R⁴)₂SiO_{2/2}
D^{2Ar}₂ is (R⁵)₂SiO_{2/2}
D^{3Vi} is (R⁶)(R⁷)SiO_{2/2}
c, d, and e are independently integers where c+d+e is from about 10 to about 10,000
a is 0-2;
b is 0-2

$$a + b = 2$$

R¹, R³, R⁴, and R⁷ are independently selected from a C1-C10 alkyl;
R² and R⁶ are independently selected from a C1-C10 alkyl and a C2-C10 alkylene group, with the proviso that at least one of R² and/or R⁶ is a C2-C10 alkylene; and
R⁵ is a C6-C30 aryl group,
where the D^{2Ar} unit is present in the vinyl-functional siloxane (A) in an amount of from about 4.8 mol. % to about 13 mol. %.

In one embodiment in accordance with any previous embodiment, the polyhydrogensiloxane is of the formula (II):

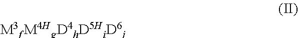

where
M³ is (R⁸)₃SiO_{1/2}
M⁴H is (R⁹)(R¹⁰)₂SiO_{1/2}
D⁴ is (R¹¹)₂SiO_{2/2}
D⁵H is (R¹²)(R¹³)SiO_{2/2}
D⁶ is (R¹⁴)₂SiO_{2/2}
f is 0-2;
g is 0-2;
f+g is 2;
h is 0-200;
i is 0-200;
j is 0-20;
h+i+j is 10-200;
g+i is ≥1;
R⁸, R¹⁰, R¹¹, and R¹² are independently selected from a C1-C10 alkyl;
R⁹ and R¹³ are independently selected from H and a C1-C10 alkyl, with the proviso that at least one of R¹⁰ or R¹³ is H; and
R¹⁴ is a C6-C30 aryl group.

In one embodiment in accordance with any previous embodiment, the organohydrogen siloxane (C) is selected from a compound of the formula (III), formula (IV), or a mixture thereof.

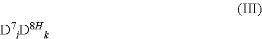

where
D⁷ is (R¹⁵)₂SiO_{2/2};
D^{8H} is (R¹⁷)(R¹⁶)SiO_{2/2};
j is 0-6;
k is 1-6;
j+k is 3-6;
R¹¹ are independently selected from a C1-C10 alkyl; and
R¹⁶ and R¹⁷ are independently selected from H and a C1-C10 alkyl, with the proviso that at least one of R¹⁶ and R¹⁷ is H;

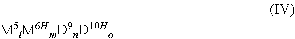

where
M⁵ is (R¹⁸)₃SiO_{1/2}
M⁶H is (R¹⁹)(R²⁰)₂SiO_{1/2}
D⁹ is (R²¹)₂SiO_{2/2}
D^{10H} is (R²³)(R²²)SiO_{2/2}
l is 0-2;
m is 0-2;
l+m is 2;
n is 0-4;
is 0-4;
n+o is ≥1;
l+m+n+o is 3-6;
R¹⁸, R²⁰, and R²¹ are independently selected from a C1-C10 alkyl; and
R¹⁹, R²³, and R²² are independently selected from H and a C1-C10 alkyl, with the proviso that at least one of R¹⁹, R²³, and/or R²² is H.

In another aspect, provided is a silicone rubber formed from the addition-cure silicone rubber composition of any of the previous aspects or embodiments.

In one embodiment, the silicone rubber is in the form of a tube, hose, gasket, or o-ring.

In still another aspect, provided is a method of making a silicone rubber comprising curing the addition-cure silicone rubber composition of any of the previous aspects or embodiments.

In yet another aspect, provided is a silicone rubber composition comprising: (A) an alkenyl-functional siloxane comprising aryl-functional siloxane units; and (B) a polyhydrogensiloxane; wherein the silicone rubber composition in the cured state has a softening temperature down to −110° C. using Differential Scanning Calorimetry (DSC); and/or wherein the cured silicone rubber is substantially free of bubbles.

In one embodiment, the aryl-functional siloxane units in an amount of from about 4.8 mol % to about 13 mol %.

In one embodiment, the silicone rubber comprises an organohydrogen siloxane (C) having six or fewer siloxane units.

In one embodiment, the organohydrogen siloxane (C) is present in an amount of from about 0.01 wt. % to about 0.8 wt. % based on the total weight amount of (B) and (C).

In one embodiment in accordance with any of the previous embodiments, the silicone rubber comprises a surface modified silica.

In one embodiment, the surface modified silica comprises silane functional groups.

In one embodiment in accordance with any of the previous embodiments, at least three different silylating agents are utilized.

In one embodiment in accordance with any of the previous embodiments, the surface modified silica is modified with a silane, a siloxane, and a silazane.

In one embodiment in accordance with any of the previous embodiments, the surface modified silica has at least 40 mol % of surface silanols modified with a functional group.

In one embodiment in accordance with any of the previous embodiments, the silicone rubber composition in the cured state has a softening temperature down to −115° C. using DSC.

In a further aspect, provided is a use of the addition-cure silicone rubber composition in accordance with any of the previous embodiments for preparing a conduit for a medical application. In one embodiment, the conduit is a tube. In one embodiment, the medical application is a pharmaceutical application. In one embodiment, the pharmaceutical application is for delivery of a medicine, vaccine, cell formulation, or cell bank.

In still another aspect provided is a use of the addition-cure silicone rubber composition in accordance with any of the previous embodiments, for preparing an o-ring seal for a gasket. In one embodiment, the gasket is employed in a component of an aircraft vehicle.

The present composition provides, when cured, a silicone rubber having excellent physical properties even at extremely low temperatures, e.g., at around −100° C. or below, and can also provide a silicone rubber with excellent clarity (transparency). Without being bound to any particular theory, applicants have found that controlling the aryl (e.g., phenyl) content of the alkenyl-functional siloxane provided excellent elastomeric properties even at very low temperatures. It also yields silicone rubber compounds with high clarity. At the meantime, controlling the amount of hydrogen siloxane with 6 or fewer siloxane units and employing the surface modified silica filler may reduce out-gassing in the system.

The following description discloses various illustrative aspects. Some improvements and novel aspects may be expressly identified, while others may be apparent from the description and drawings.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” means an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It will be appreciated that where ranges are provided in the specification and claims, numerical values may be combined to form new and non-specified ranges. For example, end points of ranges for a component may be utilized to form new and non-specified ranges.

Provided is an addition-cure rubber silicone composition, a cured rubber silicone from such a composition, and articles comprising such cured rubber silicone. The addition-cure rubber silicone compositions provide cured rubber silicone that exhibit excellent elastomeric and other physical properties at low temperatures, even temperatures of about −110° C. or below. Additionally, the present compositions provide low bubble formation upon curing.

The present addition-cure rubber silicone compositions comprise a siloxane copolymer with aryl-functional siloxane units; a polyorganohydrogen siloxane; hydrogen siloxanes having a low content of organohydrogensiloxane with six or fewer siloxane units; and a surface modified silica filler with high percentage of the surface silanol groups being functionalized.

In one embodiment, an addition-cure rubber silicone composition comprises (A) a alkenyl-functional siloxane copolymer of dialkylsiloxane, an aryl-functional siloxane, and alkyl-alkenyl-functional siloxane, where the aryl-functional siloxane unit is in the range of 4.8-13 mol %, and which provides low temperature flexibility; (B) at least one polyhydrogensiloxane as crosslinker; (C) a mixture of organohydrogensiloxane with no more than six siloxane units either in a cyclic form or in a linear form, and the total amount of component (C) is in the range of 0.01 wt % to 0.8 wt % of the amount of component (B); (D) at least one hydrosilylation catalyst comprising a transition metal to facilitate addition-cure; (E) at least one surface modified reinforcing silica filler where at least 40 mol % of surface silanol groups are functionalized (e.g., silylated); (F) optionally one or more inhibitors to component (D) to balance cure rate and pot life; and (G) optionally one or more auxiliary additives.

Component (A) is an organopolysiloxane having at least two alkenyl groups per molecule and also contains aryl-functional siloxane units. The alkenyl groups can be selected from any suitably alkenyl group. In one embodiment, the alkenyl group is a C2-C10 alkenyl group such as, but not limited to, vinyl, allyl, butenyl, pentenyl, hexenyl, and heptenyl, with vinyl and hexenyl being particularly suitable. As for the bonding position of the alkenyl group, it is, in embodiments, provided by the end(s) of the molecular chain, side chains of the molecular chain, or end(s) of the molecular chain and side chains of the molecular chain. In addition, in component (A), silicon-bonded groups other than the alkenyl groups can be selected from substituted or unsubstituted monovalent hydrocarbon groups, with the exception of alkenyl groups, such as methyl, ethyl, propyl, butyl, pentyl, hexyl, and other alkyl groups. Component (A) also includes aryl-functional siloxane units. Examples of suitable aryl groups include C6-C30 aryl groups such as, but not limited to, phenyl, tolyl, xylyl, and other aryl groups; benzyl, phenethyl, and other aralkyl groups. The molecular structure of component (A) can be linear, partially branched linear, branched, or a network structure, and component (A) may be a mixture of two or more of the above-mentioned organopolysiloxanes of different molecular structures. In addition, the zero shear viscosity of component (A) at 37° C. as determined using a creep test on a controlled stress rheometer can be selected as desired for a particular purpose or intended application. In embodiments, the zero shear viscosity of component (A) may be in the range of 100 Pascal seconds (Pa·s) to 1,000,000 Pa·s, and especially in the range of 10,000 Pa·s to 100,000 Pa·s.

In one embodiment, component (A) is exemplified by dimethylsiloxane-methylvinylsiloxane-methylphenylsiloxane copolymer having both ends of the molecular chain terminated by trimethylsiloxy groups, dimethylsiloxane-methylvinylsiloxane-methylphenylsiloxane copolymer having both ends of the molecular chain terminated by dimethylvinylsiloxy groups, dimethylsiloxane-methylvinylsiloxane-diphenylsiloxane copolymer having both ends of the molecular chain terminated by trimethylsiloxy groups, dimethylsiloxane-methylvinylsiloxane-diphenylsiloxane copolymer having both ends of the molecular chain terminated by dimethylvinylsiloxy groups, dimethylsiloxane-methylphenylsiloxane copolymer having both ends of the molecular chain terminated by dimethylvinylsiloxy groups, dimethylsiloxane-diphenylsiloxane copolymer having both ends of the molecular chain terminated by dimethylvinylsiloxy groups; dimethylsiloxane-methylvinylsiloxane copolymer having both ends of the molecular chain terminated by trimethylsiloxy groups, dimethylsiloxane-methylvinylsiloxane copolymer having both ends of the molecular chain terminated by dimethylvinylsiloxy groups, polydimethylsiloxane having both ends of the molecular chain terminated by dimethylvinylsiloxy groups, organopolysiloxanes comprising R₃SiO_{1/2} units and SiO_{4/2} units, organopolysiloxanes comprising RSiO_{3/2} units, organopolysiloxanes comprising R₂SiO_{2/2} units and RSiO_{3/2} units, organopolysiloxanes comprising R₂SiO_{2/2} units, RSiO_{3/2}, and SiO_{4/2} units, and mixtures of two or more of the above organopolysiloxanes. Radical R stands for a substituted or unsubstituted monovalent hydrocarbon group exemplified by methyl, ethyl, propyl, butyl, pentyl, hexyl, and other alkyl groups; vinyl, allyl, butenyl, pentenyl, hexenyl, heptenyl, and other alkenyl groups; phenyl, tolyl, xylyl, and other aryl groups; benzyl, phenethyl, and other aralkyl groups. In one embodiment, at least two R radicals should be alkenyl groups.

In one embodiment, the alkenyl-functional siloxane (A) is a copolymer of dialkylsiloxane, diarylsiloxane, and alkyl-vinyl siloxane of the formula (I):

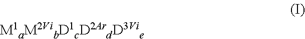

where:
M¹ is (R¹)₃SiO_{1/2}
M^{2Vi} is (R²)(R³)₂SiO_{1/2}
D¹ is (R⁴)₂SiO_{2/2}
D^{2Ar} is (R⁵)₂SiO_{2/2}
D^{3V} is (R⁶)(R⁷)SiO_{2/2}
c, d, e are integers with c+d+e is from about 10 to 10,000, preferably 100 to 10,000, more preferably 400 to 10,000, even more preferably 1,000 to about 10,000;
a is 0-2;
b is 0-2

$$a + b = 2$$

R¹, R³, R⁴, and R⁷ are independently selected from a C1-C10 alkyl;
R² and R⁶ are independently selected from a C1-C10 alkyl and a C2-C10 alkylene group, with the proviso that at least one of R² and/or R⁶ is a C2-C10 alkylene; and
R⁵ is a C6-C30 aryl group,
where the D^{2Ar} unit is present in the vinyl-functional siloxane (A) in an amount of from about 4.8 mol. % to about 13 mol. % of all siloxane units in component (A).

In one embodiment, the D^{2Ar} unit is present in an amount of from about 4.8 mol. % to about 13 mol. %, from about 5 mol. % to about 10 mol. %, or from about 5.2 mol. % to about 8 mol. % of all siloxane units in component A. The mol % of D²¹ unit in component (A) is determined using quantitation ²⁹Si nuclear magnetic resonance spectroscopy (²⁹Si NMR). Without being bound to any particular theory, providing a siloxane with a diphenyl siloxane content with this range has been found to provide the resulting silicone rubber with excellent elastomeric properties even at temperatures of below −100° C.

In one embodiment, the alkyl groups in formula (I) can be independently selected from a C1-C10 alkyl, a C2-C8 alkyl, or a C4-C6 alkyl. In one embodiment, the alkyl groups in formula (I) are methyl.

In one embodiment, the alkenyl groups in formula (I) can be independently selected from a C2-C10 alkenyl functional group, a C3-C9 alkenyl functional group, or a C4-C8 alkenyl functional group. In one embodiment, the alkenyl functional group in formula (I) is independently selected from a C2-C3 alkenyl functional group. In one embodiment the alkenyl functional group is vinyl.

In one embodiment, the aryl groups are independently selected from a C6-C30 aryl group, a C7-C20 aryl group, or a C8-C15 aryl group. In one embodiment, the aryl groups are phenyl.

In one embodiment, component (A) is present in the composition in an amount of from about 40 wt. % to about 90 wt. %, from about 50 wt. % to about 80 wt. %, or from about 60 wt. % to about 70 wt. % based on the weight of the composition.

Components (B) and (C) serve as cross-linking agents for the alkenyl-functional siloxane component A. Component (B) is an organopolysiloxane having at least two silicon-bonded hydrogen atoms per molecule. Component (C) is a organohydrogensiloxane having six or fewer siloxane units.

The bonding position of the silicon-bonded hydrogen atoms can be anywhere as desired and can be provided at the end(s) of the molecular chain, side chains of the molecular chain, or end(s) of the molecular chain and side chains of the molecular chain. In addition, in component (B), silicon-bonded groups can be substituted or unsubstituted monovalent hydrocarbon groups, with the exception of alkenyl groups, such as methyl, ethyl, propyl, butyl, pentyl, hexyl. The molecular structure of component (B) can be linear, partially branched linear, branched, or network structures, and component (B) may be a mixture of two or more of the above-mentioned organopolysiloxanes of different molecular structures. In addition, the viscosity of component (B) at 20° C. and a shear rate of 10 s⁻¹ according to DIN 53019. is preferably in the range of from 1 mPa·s to 50,000 mPa·s, and, especially preferably, in the range of from 5 mPa·s to 1,000 mpa·s.

Non-limiting examples of siloxanes in accordance with component (B) include, but are not limited to, methylhydrogenpolysiloxane having both ends of the molecular chain terminated by trimethylsiloxy groups; dimethylsiloxane-methylhydrogensiloxane copolymer having both ends of the molecular chain terminated by trimethylsiloxy groups; polydimethylsiloxane having both ends of the molecular chain terminated by dimethylhydrogensiloxy groups, methylhydrogenpolysiloxane having both ends of the molecular chain terminated by dimethylhydrogensiloxy groups; dimethylsiloxane-methylhydrogensiloxane copolymer having both ends of the molecular chain terminated by dimethylhydrogensiloxy groups; dimethylsiloxane-diphenylsiloxane copolymer having both ends of the molecular chain terminated by dimethylhydrogensiloxy groups; dimethylsiloxane-methylhydrogensiloxane-diphenylsiloxane copolymer having both ends of the molecular chain terminated by dimethylhydrogensiloxy groups, dimethylsiloxane-methylhydrogensiloxane-diphenylsiloxane copolymer having both ends of the molecular chain terminated by trimethylsiloxy groups; dimethylsiloxane-methylphenylsiloxane copolymer having both ends of the molecular chain terminated by dimethylhydrogensiloxy groups; dimethylsiloxane-methylhydrogensiloxane-methylphenylsiloxane copolymer having both ends of the molecular chain terminated by dimethylhydrogensiloxy groups, dimethylsiloxane-methylhydrogensiloxane-methylphenylsiloxane copolymer having both ends of the molecular chain terminated by trimethylsiloxy groups; organopolysiloxanes comprising R′₃SiO₂ units and SiO_{4/2} units, organopolysiloxanes comprising R′SiO_{3/2} units, organopolysiloxanes comprising R′₂SiO_{2/2} units and R′SiO_{3/2} units, organopolysiloxanes comprising R′₂SiO_{2/2} units, R′SiO_{3/2}, and SiO_{4/2} units, and mixtures of two or more of the above organopolysiloxanes. The radical R′ stands for a hydrogen atom or a substituted or unsubstituted monovalent hydrocarbon group exemplified by methyl, ethyl, propyl, butyl, pentyl, hexyl, and other alkyl groups; phenyl, tolyl, xylyl, and other aryl groups; benzyl, phenetyl, and other aralkyl groups; 3-chloropropyl, 3,3,3-trifluoropropyl, and other halogenated alkyl groups. It is preferable, however, that at least two R′ radicals should be hydrogen atoms.

In one embodiment, component (B) is of the formula (II):

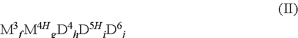

where
M³ is (R⁸)₃SiO_{1/2}
M⁴H is (R⁹)(R¹⁰)₂SiO_{1/2}
D⁴ is (R′¹)₂SiO_{2/2}
D⁵H is (R¹²)(R¹³)SiO_{2/2}
D⁶ is (R¹⁴)₂SiO_{2/2}
f is 0-2;
g is 0-2;
f+g is 2;
h is 0-200;
i is 0-200;
j is 0-20;
h+i+j is 10-200;
g+i is ≥1;
R⁸, R¹⁰, R¹¹, and R¹² are independently selected from a C1-C10 alkyl;
R⁹ and R¹³ are independently selected from H and a C1-C10 alkyl, with the proviso that at least one of R¹⁰ or R¹³ is H.
R¹⁴ is a C6-C30 aryl group,

In one embodiment, the alkyl groups in formula (II) can be independently selected from a C1-C10 alkyl, a C2-C8 alkyl, or a C4-C6 alkyl. In one embodiment, the alkyl groups in formula (II) are methyl.

In one embodiment, the aryl groups are independently selected from a C6-C30 aryl group, a C7-C20 aryl group, or a C8-C15 aryl group. In one embodiment, the aryl groups are phenyl.

Component (C) is hydrogen siloxane having six or fewer siloxane units. The component (C) can be a linear or cyclic siloxane. In one embodiment, component (C) is selected from a compound of formula (III), formula (IV), or a mixture of two or more thereof:

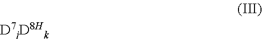

where
D⁷ is (R¹⁵)₂SiO_{2/2};
D^{8H} is (R¹⁶)(R¹⁷)SiO_{2/2};
j is 0-6;
k is 1-6;
j+k is 3-6;
R⁵ are independently selected from a C1-C10 alkyl; and
R¹⁶ and R¹⁷ are independently selected from H and a C1-C10 alkyl, with the proviso that at least one of R¹⁶ and R¹⁷ is H;

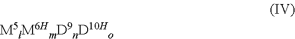

where
M⁵ is (R¹⁸)₃SiO_{1/2}
M⁶H is (R¹⁹)(R²⁰)₂SiO_{1/2}
D⁹ is (R²¹)₂SiO_{2/2}
D^{10H} is (R²³)(R²²)SiO_{2/2}
l is 0-2;
m is 0-2;
l+m is 2;
n is 0-4;
is 0-4;
n+o is ≥1;
m+o is ≥1;
l+m+n+o is 3-6;
R¹⁸, R²⁰, and R²¹ are independently selected from a C1-C10 alkyl; and
R¹⁹, R²³, and R²² are independently selected from H and a C1-C10 alkyl, with the proviso that at least one of R¹⁹, R²³, and/or R²² is H.

In one embodiment, component (C) comprises a cyclic hydrogensiloxane of the formula (III). In one embodiment, j is 0 and k is 3-6. In one embodiment, j is 0 and k is 3.

In one embodiment, the alkyl groups in formula (III) or (IV) can be independently selected from a C1-C10 alkyl, a C2-C8 alkyl, or a C4-C6 alkyl. In one embodiment, the alkyl groups in formula (III) or (IV) are methyl.

In providing components (B) and (C), it will be appreciated that they can be provided separately or as a mixture.

In one embodiment, components (B) and (C) are present in the composition in an amount of from about 0.3 wt % to about 1.2 wt %, from about 0.5 wt % to about 1 wt %, or from about 0.6 wt % to about 0.9 wt %, where component (C) is present in an amount of from about 0.01 wt. % to about 0.8 wt. %, from about 0.02 wt. % to about 0.7 wt. %, from about 0.05 wt. % to about 0.6 wt. %, from about 0.1 wt. % to about 0.5 wt. % or from about 0.1 wt. % to about 0.4 wt. % based on the total weight of components (B) and (C).

The percentage of component (C) in a mixture of components (B) and (C) is determined using gas chromatography (GC) performed directly on the mixture. D4 (octamethylcyclotetrasiloxane) is used as the internal standard for quantification.

The composition includes a hydrosilylation catalyst (D) to promote the addition reaction of the alkenyl functional groups of component (A) with the Si—H functional groups of components (B) and (C). The hydrosilylation catalyst is not particularly limited and can be selected from any catalyst suitable for promoting hydrosilylation of the alkenyl functional groups with the hydride groups. Suitable hydrosilylation catalysts include, but are not limited to, metals or metal compounds whereby the metal is selected from the group of nickel, palladium, platinum, rhodium, iridium, ruthenium and osmium or as taught in U.S. Pat. Nos. 3,159,601; 3,159,662 (Ashby); U.S. Pat. Nos. 3,419,593; 3,715,334; 3,775,452; 3,220,970 (Lamoreaux); and U.S. Pat. No. 3,814,730 (Karstedt).

The amounts of these catalysts which are added to the composition is from 0.5 to 500 ppm, preferably between 1 and 100 ppm, most preferably between 1.5 and 10 ppm based on the total weight the composition.

In one embodiment, the catalyst is selected from a platinum-containing catalyst. Examples of suitable platinum-containing catalyst components include, but are not limited to, platinum metal; a carrier such as silica gel or powdered charcoal bearing platinum metal; or a compound or complex of a platinum metal.

A typical platinum-containing catalyst component in the organopolysiloxane compositions of this invention is any form of chloroplatinic acid, such as, for example, the readily available hexahydrate form or the anhydrous form, because of its easy dispersibility in organosiloxane systems. A particularly useful form of chloroplatinic acid is that composition obtained when it is reacted with an aliphatically unsaturated organosilicon compound such as divinyltetramethyl-disiloxane as disclosed by U.S. Pat. No. 3,419,593, incorporated herein by reference or tetravinyl-tetramethyl-tetracyclosiloxane. Ashby's catalyst, Karstedt's catalyst, and Lamoreaux's catalyst are conventional catalyst that may be used to cure the silicone rubber composition. It will be understood herein that any known or commercially used photo-activated catalyst can be employed herein, most specifically a photo-activated platinum catalyst. In one embodiment, the photo-activated platinum catalyst is selected from the group consisting of η⁵-cyclopentadienyl platinum(IV) complexes, bis(β-diketonate) platinum(II) complexes, bis(phosphine) platinum(II) complexes, cyclooctadiene platinum(II) complexes, and mixtures thereof, more specifically trimethyl(methylcyclopentadienyl) platinum(IV) or platinum(II) acetylacetonate.

The composition further comprises a surface modified silica filler (E). Silica particles contain residual silanol group (—Si—OH) on their surface. The modified silica particles are provided by reacting silanol groups with a desired functional group. In one embodiment, the silica particles are modified with a silane to provide a silylated silica.

The silica particles are not particularly limited and can be selected as desired. In one embodiment, the silica particles are colloidal silica. Generally, any colloidal silica can be used. Examples of suitable colloidal silica include, but are not limited to, fumed colloidal silica and precipitated colloidal silica. Particularly suitable colloidal silicas are those that are available in an aqueous medium. Colloidal silicas in an aqueous medium are usually available in a stabilized form, such as those stabilized with sodium ion, ammonia, or an aluminum ion. The colloidal silica may have particle diameters of from 5 to 250 nanometers, more specifically 6 to 150 nanometers, even from 8 to 85 nanometers. Silica filler can have a Brunauer-Emmett-Teller (BET) specific surface area from 50 to 400 m²/g, preferably 150 to 350 m²/g.

In one embodiment, the particle diameters for the colloidal silica are determined in accordance with ASTM E2490-09 (2015), Standard Guide for Measurement of Particle Size Distribution of Nanomaterials in Suspension by Dynamic Light Scattering (DLS).

The colloidal silica particles, which may also be referred to as silica sols herein, may be derived from e.g. precipitated silica, micro silica (silica fume), pyrogenic silica (fumed silica) or silica gels with sufficient purity, and mixtures thereof; they may be silanised by way of the method described in WO2004/035474. The silica sol may also, typically, be obtained from waterglass as disclosed in e.g. U.S. Pat. No. 5,368,833.

The silica particles can be modified with any suitable silylation agents. In one embodiment, silica can be functionalized with an organosilane, an alkylsilanes, and/or a silazane. Examples of suitable silylation agents for modifying the silica particles include, but are not limited to, tris-(trimethoxy)silane, octyl triethoxysilane, methyl triethoxysilane, methyl trimethoxysilane; bis-(3-[triethoxysilyl]propyl)polysulfide, beta-(3,4-epoxycyclohexyl)-ethyl trimethoxysilane, gamma-methacryloxypropyl trimethoxysilane, gamma-methacryloxypropyl triisopropoxysilane, gamma-methacryloxypropyl triethoxysilane, octyltrim ethyl oxy silane, ethyltrimethoxy silane, propyltriethoxy silane, phenyltrimethoxy silane, cyclohexyltrimethoxy silane, cyclohexyltriethoxy silane, dimethyldimethyoxy silane, 3-chloropropyltriethoxy silane, 3-methacryloxypropyltrimethoxy silane, i-butyltriethoxy silane, trimethylethoxy silane, phenyldimethylethoxy silane; silanes containing an epoxy group (epoxy silane), glycidoxy and/or a glycidoxypropyl group such as gamma-glycidoxypropyl trimethoxysilane, gamma-glycidoxypropyl methyldiethoxysilane, (3-glycidoxypropyl)triethoxy silane, (3-glycidoxypropyl) hexyltrimethoxy silane, beta-(3,4-epoxycyclohexyl)-ethyltriethoxysilane; silanes containing a vinyl group such as vinyl triethoxysilane, vinyl trimethoxysilane, vinyl tris-(2-methoxyethoxy)silane, vinyl methyldimethoxysilane, vinyl triisopropoxysilane; hexamethyldisiloxane, trimethylsilyl chloride, vinyltriethoxy silane, hexamethyldisilizane, tetramethyldivinyldisilazane, octamethylcyclotetrasiloxane, polydimethylsiloxane, and mixtures thereof. According to one embodiment, silane compounds with mercapto functionality may be used, for example 3-mercaptopropyltrimethoxysilane, 3-mercaptopropyltriethoxy silane, HS(CH₂)₃, Si(OCH₃)₃, mercapiosilane possessing at least one hydroxyalkoxysilyl group and/or a cyclic diaikoxysiiyi group, gamma-mercaptopropyl trimethoxysilane, gamma-mercaptopropyl triethoxysilane, gamma-mercaptopropyl trimethoxysilane. Further, silica powder surface-treated by an organosilicon compound such as polydimethylsiloxane, octamethylcyclotetrasiloxane, or hexamethyldisilazane may be used.

Silazanes, such as disilazanes can also be employed to provide a modified silica. Disilazanes, which can be employed in the include for example, but are not limited to, hexamethyldisilazane, diinylteirarnethyldisilazane and bis(3,3-trifluoropropyl)tetramethyldisilazane. Cyclosilazanes are also suitable, and include, for example, octanethylcyclotetrasilazane.

In one embodiment, the surface modified silica filler is modified with a plurality of silylating agents. In embodiments, the surface modified silica filler is modified with three or more types of silylating agents. In embodiments, the surface modified silica filler is modified with a silylating agent selected from a silane and a siloxane. In one embodiment, the surface modified silica filler is modified with a silylating agent selected from a silane, a siloxane, and a silazane.

The silica particle for use in the present composition have at least 40 mol. % of the surface silanol groups functionalized (e.g., silylated). In one embodiment 40 mol. % to about 100 mol. % of the silanol groups are silylated, from about 45 mol. % to about 85 mol. %, from about 50 mol. % to about 70 mol. % of the silanol groups are silylated. The percentage of silylated surface silanol in fumed silica can be determined using ²⁹Si cross-polarization and magic angle spinning nuclear magnetic resonance spectroscopy (CP/MAS NMR) at 10 ms contact time. For example, a fumed silica with a BET specific surface area of 200 m²/g can have ca. 30 mol. % of surface silanol groups functionalized when treated with octamethylcyclotetrasiloxane. The same fumed silica can have ca. 40 mol. % of surface silanol groups functionalized when treated with both octamethylcyclotetrasiloxane and hexamethyldisilazane.

The surface modified silica particles can be present in the composition in an amount of from about 1 wt. % to about 50 wt. %, from about 15 wt. % to about 40 wt. %, or from about 25 wt. % to about 35 wt. % based on the weight of the composition.

The composition may further contain additives which are typical for silicone rubber compositions, including fillers, rheology control agents, reactive and non-reactive plasticizers, adhesion promoters, various kinds of reinforcement, pigments, dyes, flame retardants, thermal and UV stabilizers, etc.

Inhibitors may also be employed. Inhibitors are additives which are used for controlled adjustment of the processing time and rate of crosslinking of the curable silicone rubber composition. These inhibitors and stabilizers may be, for example, acetylenic alcohols such as ethynylcyclohexanol and 2-methyl-3-butyn-2-ol, polymethylvinylcyclosiloxanes such as methylvinylcyclotetrasiloxane, low molecular weight siloxane oils having vinyldimethylsiloxy end groups, trialkyl cyanurates, alkyl maleates, such as diallyl maleate and dimethyl maleate, alkyl fumarates, such as diethyl fumarate and diallyl fumarate, organic hydroperoxides, such as cumene hydroperoxide, tert-butyl hydroperoxide and pinane hydroperoxide, organic peroxides, benzotriazole, organic sulfoxides, organic amines and amides, phosphines, phosphites, nitriles, diaziridines and oximes.

The silicone rubber composition can be press-cured at 175° C. for 10 min. In one embodiment, the silicone rubber composition is cured via a vertical tubing extrusion line at 20 feet per minute line-speed, wherein a two-foot long lower oven chamber is set at 480° C. and a two-foot long upper oven chamber is set at 420° C.

The silicone rubber substrate can be prepared by converting a curable silicone composition into a desired shape by conventional methods, such as compression molding, injection molding, extrusion, and calendaring; and then curing the composition. As used herein, the term “curing” means the conversion of a liquid or semisolid composition to a cross-linked product. Examples of curable silicone compositions include, but are not limited to, hydrosilylation-curable silicone compositions, ultraviolet radiation-curable silicone compositions, and high-energy radiation-curable silicone compositions.

The cured rubber article produced from a composition in accordance with the present technology exhibits excellent elastomeric properties even at low temperatures including temperatures below −100° C., below −110° C., and even below −115° C. In one embodiment, the silicone rubber produced from a composition in accordance with the present technology is substantially free of bubbles. In one embodiment, a silicone rubber produced from a composition in accordance with the present technology has a transmittance of 85% or greater, 90% or greater, 95% or greater.

The present compositions can be used to form articles of a desired shape for a variety of purposes or end uses. Examples of suitable articles include, but are not limited to conduits, gaskets, seals, o-rings, etc. Conduits can include, but are not limited to, tubing, pipes, channels, and the like. The articles formed from the present compositions can be employed in a variety of end uses and applications. In one embodiment, an article can be employed in aeronautical applications. For example, an article formed from the present compositions can be employed as or in conjunction with components on aircraft vehicles. Aircraft vehicles include both aviation and aerospace vehicles, i.e., the components can be employed on aircraft operating within or outside of the earth's atmosphere.

In one embodiment, an article formed from the composition can be employed as a conduit to transport a material or fluid therein. Conduits can include tubing, pipes, channels, and the like. Conduits formed from the composition can be employed in a wide variety of applications including, but not limited to medical applications. The conduits can be employed to transmit fluids in various medical applications. This can be for pharmaceutical applications such as, for example, delivery of medicines, drugs, vaccines, cell formulations, plasma, other such fluids, and the like.

Aspects and embodiments of the technology may be further understood with respect to the following examples. The examples are for the purpose of illustrating aspects and embodiments of the technology and not intended to limit the technology to those specific embodiments.

### EXAMPLES

As illustrated in Table 1, softening point of dimethylsiloxane copolymers can be dropped from −40° C. to −115° C. when only around 5 mol % of diphenylsiloxane unit is introduced in the polydimethylsiloxane chain. Without being bound to any particular theory, randomly distributed bulky diphenylsiloxane units can effectively suppress the crystallization of polydimethylsiloxane. When more diphenylsiloxane units are introduced at 14 mol %, its softening point is then increased to −98° C. due to the increase of its glass transition temperature.

TABLE 1
Softening point of dimethylsiloxane copolymers having both
ends terminated with a vinyldimethylsiloxy group, and
containing different amount of diphenylsiloxane units.

| | mol % | Softening |
|---|---|---|
| | Diphenylsiloxane | point |
| | unit | (° C.) |
| Dimethylsiloxane copolymer 0 (0% | 0.0% | −40 |
| diphenylsiloxane units, 25,000 Pa · s) | | |
| Dimethylsiloxane copolymer 1 (5.3 mol % | 5.3% | −115 |
| diphenylsiloxane units, 63,000 Pa · s) | | |
| Dimethylsiloxane copolymer 2 (6.0 mol % | 6.0% | −115 |
| diphenylsiloxane units, 70,000 Pa · s) | | |
| Dimethylsiloxane copolymer 3 | 14.0% | −98 |
| (14.0 mol % diphenylsiloxane units, | | |
| 105,000 Pa · s) | | |

The thermal property (e.g., softening point) of the samples is determined using differential scanning calorimetry (DSC). In the temperature range of −180° C. and +100° C. at a heating rate of 10° C./min with 5 min waiting time between steps using a TA Instruments Discovery 2500 DSC. For a crystalline polymer, the softening point is its melting point, and for an amorphous polymer, the softening temperature is its glass transition temperature.

### Example 1

In a double sigma blade dough mixer, 64.5 parts of copolymer 1 of dimethylsiloxane, diphenylsiloxane, and di-methyl vinylsiloxane (component A), which has a viscosity of 63,000 Pa·s and contains 5.3 mol % of diphenylsiloxane unit and 0.012 mol/kg of vinyl groups (Si-vinyl), was mixed with the following silylating agents: 1.9 parts of silanol-stopped polydimethylsiloxane with a viscosity of 30 cSt, 0.85 parts of hexamethyldisilazane, and 0.15 parts of tetramethyldivinyldisilazane. Then 30.8 parts of pre-treated fumed silica filler, which originally had a Brunauer-Emmett-Teller (BET) specific surface area of 320 m²/g and was later treated with octamethylcyclotetrasiloxane (D4) at 265° C. for 2 hours, was charged into the kneader. The mixture was heated to 160° C. and then retained at 160° C. for at least 2 hours under the blanket of nitrogen inertion to allow adequate reaction between residual surface silanol on pre-treated filler surface and the above mentioned three silylating agents. The resultant filler after this additional in situ treatment was regarded as component E. At least three different types of silylating agents were employed in producing component E, which included D4, a silanol-stopped silicone, and two disilazanes, making it hydrophobic enough to minimize its moisture adsorption and thereby diminishing the moisture content in the silicone compound. After the silicone compound was cooled down below 70° C., 0.8 parts of a blend of dimethylhydrogensiloxy-terminated poly(dimethylsiloxane-co-methylhydrosiloxane) (component B) and methylhydrosiloxane compounds (component C) were added. The blend contained 8.1 mol/kg of silicon hydride group (SiH) as determined by Fourier transform infrared measurement. Component B had a formula of M^{H}₂ D₅₀D^{H}₅₀. Component C was a mixture of D^{H}₃, DₓD^{H}_{y} (wherein x and y=0-6 and x+y=4-6), and MₘM^{H}ₙ DₓD^{H}_{y} (wherein m and n=0-2, x and y=0-4, m+n=2, and m+n+x+y=3-6). There was 0.13 wt % of component C in this blend of components B and C as determined by GC. Lastly, 0.009 parts of 1-ethynyl-1-cyclohexanol (component F) as the Pt inhibitor was added to the mixture to finish the silicone rubber base compound. Separately, a Pt catalyst masterbatch (component D) was prepared by mixing 1 part of the above-mentioned component A and 0.017 parts of a solution of Ashby Pt catalyst in tetramethyl tetravinyl cyclotetrasiloxane that contains 1.75 wt % Pt.

The silicone rubber base compound and the Pt masterbatch was mixed at 99:1 ratio and subject to press-cure at 175° C. for 10 min. The SiH to Si-vinyl molar ratio in this catalyzed blend was 2.9. The cured article exhibited high clarity with 90% transmittance and 12% haze at 2 mm per ASTM D 1003. It also exhibited good mechanical properties with a high tear resistance at 49 N/mm per ASTM D-624. The cured article has a softening point at −114° C. per DSC measurement.

The catalyzed blend was also subject to extrusion into 9/16″ outer diameter and 5/16″ inner diameter tubing with a wall thickness of ⅛″. The tubing extrusion was run vertically with a 2-foot long lower oven chamber set at 480° C. and a 2-foot long upper oven chamber set at 425° C. The line speed was set at 20 feet per minute. Extrusion ran smoothly and yielded clear and bubble-free tubing. The tubing was coiled together right at the end of extrusion line while it was still hot. The coiled tubing did not stick together after overnight storage, indicating that the vulcanization was complete during the extrusion; otherwise, the tubing would have had fused together during storage.

### Example 2

Example 2 employed composition identical to Example 1 except that the amount of both Pt catalyst (component D) and inhibitor (component F) were cut in half. It exhibited identical optical, mechanical, and thermal properties of Example 1, as shown in Table 2. During tubing extrusion with the same line speed as Example 1, the temperature of the lower chamber had to be raised to 535° C. and the temperature of the upper chamber was raised to 480° C. to retain adequate cure rate so that the coiled tubing would not stick together upon storage. The extruded tubing was also clear and bubble-free like Example 1.

### Example 3

Example 3 employed a different copolymer 2 of dimethylsiloxane, diphenylsiloxane, and di-methyl vinylsiloxane as component A. Copolymer 2 contained 6 mol % diphenylsiloxane unit and had a viscosity of 70,000 Pa·s. Its Si-vinyl content remained the same as copolymer 1. The resultant silicone rubber exhibited good tear resistance at 33 N/mm per ASTM D-624 though it was lower than that of Example 1. It retained high clarity with 90% transmittance and 12% haze per ASTM D 1003. It had a low softening point at −115° C. per DSC. The tubing extrusion run smoothly under the same extrusion condition of Example 1. The tubing was bubble-free, and the coiled tubing did not stick together upon storage.

### Example 4

Example 4 employed 62.5 parts of copolymer 1, 2 parts of dimethylsiloxane and di-methyl vinylsiloxane copolymer 0 that didn't contain any diphenylsiloxane units and had a viscosity of 25,000 Pa·s and a vinyl content of 0.028 mol/kg (Si-vinyl). The other inputs are the same as those employed in Example 1. Due to the inclusion of non-phenyl containing copolymer 0, the mol % of diphenylsiloxane unit in component A was dropped from 5.3 mol % (as in Example 1) to 5.1 mol %. As a result, subsequent vulcanized silicone rubber had slightly higher softening point at −112° C. Its clarity also dropped slightly with transmittance at 87% and haze at 15% probably due to somewhat immiscibility between diphenyl-containing copolymer 1 and diphenyl-free copolymer 0. The material still exhibited good mechanical performance with a high tear resistance at 49 N/mm per ASTM D-624. Tubing extrusion also ran well like Example 1. The tubing was bubble-free, and the coiled tubing did not stick together upon storage.

### Comparative Example 1

When more component C was incorporated into Example 1, whose concentration in the blend of components B and C was increased from 0.13 wt % to 2.4 wt %, the resultant material yielded bubbles during tubing extrusion, and the bubbles could not be eliminated by adjusting extrusion conditions. Without being bound to any particular theory, the bubbles may have been caused by higher levels of volatile SiH compounds that reacted with moisture and released hydrogen gas. The softening point of the tubing remained the same as Example 1 since the diphenyl content remained the same as Example 1, as shown in Table 2.

Mechanical and optical properties were measured on press-cured sheets (instead of on extruded tubing) per ASTM D-624 and D-1003, respectively. Press-cured sheets, unlike extruded tubing, rarely contain bubbles because they typically employ high pressure during vulcanization (e.g., 200 psi). Such a high pressure can press out bubbles, if there are any, off a sheet during vulcanization. Unfortunately, tubing extrusion is generally conducted under ambient pressure (i.e., ca. 0 psi), making it susceptible to the retention of bubbles that may be generated from side reactions such as dehydrogenative condensation. Tubing extrusion also employs a much higher temperature (400° C. compared to 175° C. for press-cure) to ensure fast and adequate curing during the process. High temperatures also favor side reactions such as the out-gassing condensation reaction, making tubing extrusion more susceptible to bubble generation.

Comparative example 1 exhibited similar mechanical and optical performance compared to Example 1, as illustrated in Table 2. For example, press-cured sheets still showed high clarity with 90% transmittance and 12% haze at 2 mm per ASTM D 1003, and it still possessed high tear resistance at 44 N/mm per ASTM D-624. Nevertheless, out-gassing and bubble formation are inevitable when extruding this composition that contains much higher volatile SiH content than Example 1.

### Comparative Example 2

When less silylating agents were employed during the cook step, wherein silanol-stopped silicone was omitted as compared to Example 2, in situ generated component (E) would tend to have more unreacted silanols on filler surface. The resultant material yielded bubbles during tubing extrusion that could not be eliminated by adjusting extrusion conditions. The amount of components (B) and (C) blend was adjusted accordingly to retain the same SiH to Si-vinyl ratio as that of Example 2, and the wt % of component (C) in the mixture stayed the same at 0.13%. Similar to Comparative Example 1, the press-cured sheets had no bubbles and thereby exhibited high tear strength at 55 N/mm per ASTM D-624, high transmittance at 91%, and low haze at 12% per ASTM D 1003. Nevertheless, bubble formation was inevitable for this composition that had less filler treatment vs. Example 2.

### Comparative Examples 3 and 4

Component (E) utilized in Comparative Examples 3 and 4 was different from that in Example 1. Untreated fumed silica filler with a BET specific surface area of 320 m²/g was employed instead of pre-treated silica filler during the cook step. As a result, only two types of silyating agents (silanol-stopped silicone and disilazanes) were employed in comparative examples 3 and 4 as compared to three different types of silylating agents (D4, silanol-stopped silicone and disilazanes) employed in Example 1. The former would tend to yield a Component (E) with more unreacted silanols.

In comparative Example 3, same high amount of component (C) (2.40 wt %) was employed as in comparative Example 1. Many bubbles were observed during tubing extrusion. When the level of component (C) was dropped down to 0.89 wt % in comparative Example 4, bubble generation was reduced although not completely removed. Reducing the amount of low volatile SiH compounds did seem to help improve the bubble issue during tubing extrusion.

Press-cured sheets had no bubbles. As a result, both compositions yielded high tear strength (39 N/mm), high transmittance (90%), and low haze (12%), as illustrated in Table 2. Both compositions also yielded −114° C. softening point in cured articles due to their suitable amount of diphenylsiloxane content, also shown in Table 2. However, their lower level of silylation on silica filler and their higher Component (C) content (see Table 2) as compared to Examples 1-4 rendered neither of them suitable in producing useful tubing due to bubble formation during the extrusion.

### Comparative Example 5

As compared to Example 4, significantly more copolymer 0 was charged while equivalent amount of copolymer 1 was displaced. The mol % of diphenylsiloxane unit in the all siloxane units in component A was reduced to 4.6%, as shown in Table 2. Although the resulting material yielded bubble free tubing upon extrusion likely due to its adequate silylation on silica surface by using three different types of silylating agents, and suitable amount of Component C (same as Example 4, see Table 2), it lost low temperature flexibility. The softening point was increased dramatically to −56° C., likely due to the incorporation of too much dimethylsiloxane based polymer and the dilution of overall diphenylsiloxane content. Clarity also suffered greatly with a much lower transmittance at 76 and a much high haze at 35% because of somewhat immiscibility between diphenyl-containing copolymer 1 and diphenyl-free copolymer 0.

TABLE 2
Compositions (in parts per weight) of various examples and corresponding properties

| | | Examples | | | | Comparative examples | | | | |
|---|---|---|---|---|---|---|---|---|---|---|
| | | 1 | 2 | 3 | 4 | 1 | 2 | 3 | 4 | 5 |
| Step 1: Cook | | | | | | | | | | |
| Compo- | Vinyl | 64.50 | 64.50 | | 62.50 | 64.50 | 64.20 | 64.70 | 64.70 | 56.40 |
| nent A | dimethylsiloxy | | | | | | | | | |
| | terminated | | | | | | | | | |
| | Dimethylsiloxane | | | | | | | | | |
| | copolymer 1 | | | | | | | | | |
| | (5.3 mol % | | | | | | | | | |
| | diphenylsiloxane, | | | | | | | | | |
| | 0.012 mol/kg | | | | | | | | | |
| | SiVi) | | | | | | | | | |
| | Vinyl | | | 64.50 | | | | | | |
| | dimethylsiloxy | | | | | | | | | |
| | terminated | | | | | | | | | |
| | Dimethylsiloxane | | | | | | | | | |
| | copolymer 2 | | | | | | | | | |
| | (6.0 mol % | | | | | | | | | |
| | diphenylsiloxane, | | | | | | | | | |
| | 0.012 mol/kg | | | | | | | | | |
| | SiVi) | | | | | | | | | |
| | Vinyl | | | | 2.00 | | | | | 8.10 |
| | dimethylsiloxy | | | | | | | | | |
| | terminated | | | | | | | | | |
| | Dimethylsiloxane | | | | | | | | | |
| | copolymer 0 | | | | | | | | | |
| | (0% | | | | | | | | | |
| | diphenylsiloxane, | | | | | | | | | |
| | 0.028 mol/kg | | | | | | | | | |
| | SiVi) | | | | | | | | | |
| Compo- | Untreated | | | | | | | 28.00 | 28.00 | |
| nent E | fumed silica | | | | | | | | | |
| | D4-treated | 30.80 | 30.80 | 30.80 | 30.80 | 30.80 | 30.20 | | | 30.80 |
| | fumed silica | | | | | | | | | |
| | Silanol- | 1.90 | 1.90 | 1.90 | 1.90 | 1.90 | | 3.60 | 3.60 | 1.90 |
| | terminated | | | | | | | | | |
| | silicone | | | | | | | | | |
| | Hexamethyl | 0.85 | 0.85 | 0.85 | 0.85 | 0.85 | 1.90 | 1.35 | 1.35 | 0.85 |
| | disilazane | | | | | | | | | |
| | Tetramethyl | 0.15 | 0.15 | 0.15 | 0.15 | 0.15 | 0.10 | 0.15 | 0.15 | 0.15 |
| | divinyldisilazane | | | | | | | | | |
| | Water | | | | | | 2.00 | 0.40 | 0.40 | |
| Step 2: Blend | | | | | | | | | | |
| Compo- | Hydride | 0.80 | 0.80 | 0.80 | 0.80 | 0.80 | 0.60 | 0.80 | 0.80 | 0.80 |
| nent B | silicone | | | | | | | | | |
| | M^{H}₂D₅₀D^{H}₅₀ | | | | | | | | | |
| Compo- | Methylhydro- | 10.5 | 10.5 | 10.5 | 10.5 | 192 | 7.9 | 192 | 71 | 10.5 |
| nent C | siloxane | ppm | ppm | ppm | ppm | ppm | ppm | ppm | ppm | ppm |
| | compounds | | | | | | | | | |
| Compo- | Ethynyl | 90 | 45 | 90 | 90 | 90 | 45 | 90 | 90 | 90 |
| nent F | cyclohexanol | ppm | ppm | ppm | ppm | ppm | ppm | ppm | ppm | ppm |
| Step 3: Catalyzation | | | | | | | | | | |
| Compo- | Ashby Pt | 170 | 85 | 170 | 170 | 170 | 85 | 170 | 170 | 170 |
| nent D | catalyst | ppm | ppm | ppm | ppm | ppm | ppm | ppm | ppm | ppm |
| Compo- | Vinyl | 1.00 | 1.00 | | 1.00 | 1.00 | 1.00 | 1.00 | 1.00 | 1.00 |
| nent A | dimethylsiloxy | | | | | | | | | |
| | terminated | | | | | | | | | |
| | Dimethylsiloxane | | | | | | | | | |
| | copolymer 1 | | | | | | | | | |
| | (5.3 mol % | | | | | | | | | |
| | diphenylsiloxane, | | | | | | | | | |
| | 0.012 mol/kg | | | | | | | | | |
| | SiVi) | | | | | | | | | |
| | Vinyl | | | 1.00 | | | | | | |
| | dimethylsiloxy | | | | | | | | | |
| | terminated | | | | | | | | | |
| | Dimethylsiloxane | | | | | | | | | |
| | copolymer 2 | | | | | | | | | |
| | (6.0 mol % | | | | | | | | | |
| | diphenylsiloxane, | | | | | | | | | |
| | 0.012 mol/kg | | | | | | | | | |
| | SiVi) | | | | | | | | | |
| | mol % | 5.3% | 5.3% | 6.0% | 5.1% | 5.3% | 5.3% | 5.3% | 5.3% | 4.6% |
| | Diphenylsiloxane | | | | | | | | | |
| | in component A | | | | | | | | | |
| | wt % | 0.13% | 0.13% | 0.13% | 0.13% | 2.40% | 0.13% | 2.40% | 0.89% | 0.13% |
| | Component C | | | | | | | | | |
| | in the | | | | | | | | | |
| | mixture of | | | | | | | | | |
| | components B | | | | | | | | | |
| | and C by GC | | | | | | | | | |
| | Number of | 3 | 3 | 3 | 3 | 3 | 2 | 2 | 2 | 3 |
| | silylation | | | | | | | | | |
| | types in | | | | | | | | | |
| | component E | | | | | | | | | |
| | Softening | −114 | −114 | −115 | −112 | −114 | −114 | −114 | −114 | −56 |
| | point (° C.) of | | | | | | | | | |
| | component A | | | | | | | | | |
| | by DSC | | | | | | | | | |
| | Softening | −114 | −114 | −115 | −112 | −114 | −114 | −114 | −114 | −56 |
| | point (° C.) of | | | | | | | | | |
| | cured article | | | | | | | | | |
| | by DSC | | | | | | | | | |
| | Bubbles in | no | no | no | no | yes | yes | yes | yes | no |
| | tubing | | | | | | | | | |
| | Tear strength | 49 | 49 | 33 | 49 | 44 | 55 | 39 | 39 | 45 |
| | (N/mm) | | | | | | | | | |
| | % Transmittance | 91 | 91 | 90 | 87 | 90 | 91 | 90 | 90 | 76 |
| | % Haze | 12 | 12 | 12 | 15 | 12 | 12 | 12 | 12 | 35 |

From Table 2 above, it is very clear that the inventive examples (Examples 1 to 4 of the table above) lead to compositions substantially free from bubbles, yet having a softening point of less than −110 degrees Celsius (−114, −112, or −115 degrees Celsius in particular). It is notable that such a desired combination of attributes is achieved without compromising on high (33 or 49 N/mm) tear strengths and high (87-91%) percentage transmittance to visible light. In comparison, however, all the compositions of comparative examples having the desired softening point of −114 degree Celsius had notable bubble formation that is commercially quite undesirable.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing description identifies various, non-limiting embodiments of an addition-cure silicone rubber composition, a silicone rubber formed from such a composition, and an article comprising such a silicone rubber. Modifications may occur to those skilled in the art and to those who may make and use the invention. The disclosed embodiments are merely for illustrative purposes and not intended to limit the scope of the invention or the subject matter set forth in the claims.

1. An addition-cure silicone rubber composition comprising:
(A) an alkenyl-functional siloxane comprising aryl-functional siloxane units in an amount of from about 4.8 mol % to about 13 mol %;
(B) a polyhydrogensiloxane;
(C) an organohydrogen siloxane different from the polyhydrogensiloxane (B), the organohydrogen siloxane (C) having six or fewer siloxane units, wherein the organohydrogen siloxane (C) is present in an amount of from 0.01 wt. % to 0.8 wt. % of the total weight amount of (B) and (C);
(D) a hydrosilylation catalyst;
(E) a surface modified silica;
(F) optionally an inhibitor; and
(G) optionally an auxiliary additive.

2. The addition-cure silicone rubber composition of claim 1, wherein the surface modified silica has at least three different types of silylating agents.

3. The addition-cure silicone rubber composition of claim 2, wherein the surface modified silica is modified with both a silane and a siloxane.

4. The addition-cure silicone rubber composition of claim 2, wherein the surface modified silica is modified with a silane, a siloxane, and a silazane.

5. The addition-cure silicone rubber composition of claim 2, wherein the surface modified silica has at least 40 mol % of surface silanols modified with a functional group.

6. The addition-cure silicone rubber composition of claim 2, wherein 45 mol % to 85 mol % of surface silanols of the surface modified silica are modified with a functional group.

7. The addition-cure silicone rubber composition of claim 1, wherein the alkenyl-functional siloxane (A) has from about 5 mol % to about 10 mol % of aryl-functional siloxane units.

8. The addition-cure silicone rubber composition of claim 1, wherein the organohydrogen siloxane (C) is present in an amount of from 0.05 wt. % to 0.6 wt. % of the total weight amount of (B) and (C).

9. The addition-cure silicone rubber composition of claim 1, wherein the organohydrogen siloxane (C) is present in an amount of from 0.1 wt. % to 0.5 wt. % of the total amount of (B) and (C).

10. The addition-cure silicone rubber composition of claim 1, wherein the alkenyl-functional siloxane is of the formula (I): 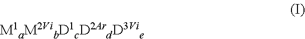
where:
M¹ is (R¹)₃SiO_{1/2}
M^{2Vi} is (R²)(R³)₂SiO_{1/2}
D¹ is (R⁴)₂SiO_{2/2}
D^{2Ar}₂ is (R⁵)₂SiO_{2/2}
D^{3Vi} is (R⁶)(R⁷)SiO_{2/2}
c, d, and e are independently integers where c+d+e is from about 10 to about 10,000
a is 0-2;
b is 0-2
$$a + b = 2$$
R¹, R³, R⁴, and R⁷ are independently selected from a C1-C10 alkyl;
R² and R⁶ are independently selected from a C1-C10 alkyl and a C2-C10 alkylene group, with the proviso that at least one of R² and/or R⁶ is a C2-C10 alkylene; and
R⁵ is a C6-C30 aryl group,
where the D^{2Ar} unit is present in the vinyl-functional siloxane (A) in an amount of from about 4.8 mol. % to about 13 mol. %.

11. The addition-cure rubber silicone composition of claim 1, wherein the polyhydrogensiloxane is of the formula (II): 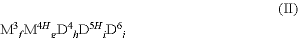
where
M³ is (R⁸)₃SiO_{1/2}
M⁴H is (R⁹)(R¹⁰)₂SiO_{1/2}
D⁴ is (R¹¹)₂SiO_{2/2}
D^{5H} is (R¹²)(R¹³)SiO_{2/2}
D⁶ is (R¹⁴)₂SiO_{2/2}
f is 0-2;
g is 0-2;
f+g is 2;
h is 0-200;
i is 0-200;
j is 0-20;
h+i+j is 10-200;
g+i is ≥1;
R⁸, R¹⁰, R¹¹, and R¹² are independently selected from a C1-C10 alkyl;
R⁹ and R¹³ are independently selected from H and a C1-C10 alkyl, with the proviso that at least one of R¹⁰ or R¹³ is H; and
R¹⁴ is a C6-C30 aryl group.

12. The addition-cure silicone rubber composition of claim 1, wherein the organohydrogen siloxane (C) is selected from a compound of the formula (III), formula (IV), or a mixture thereof: 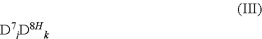
where
D⁷ is (R¹⁵)₂SiO_{2/2};
D^{8H} is (R¹⁷)(R¹⁶)SiO_{2/2};
j is 0-6;
k is 1-6;
j+k is 3-6;
R⁵ are independently selected from a C1-C10 alkyl; and
R¹⁶ and R¹⁷ are independently selected from H and a C1-C10 alkyl, with the proviso that at least one of R¹⁶ and R¹⁷ is H; 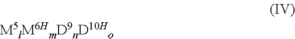
where
M⁵ is (R¹⁸)₃SiO_{1/2}
M⁶H is (R¹⁹)(R²⁰)₂SiO_{1/2}
D⁹ is (R²¹)₂SiO_{2/2}
D^{10H} is (R²³)(R²²)SiO_{2/2}
l is 0-2;
m is 0-2;
l+m is 2;
n is 0-4;
o is 0-4;
n+o is ≥1;
l+m+n+o is 3-6;
R¹⁸, R²⁰, and R²¹ are independently selected from a C1-C10 alkyl; and
R¹⁹, R²³, and R²² are independently selected from H and a C1-C10 alkyl, with the proviso that at least one of R¹⁹, R²³, and/or R²² is H.

13. A silicone rubber formed from the addition-cure silicone rubber composition of claim 1.

14. The silicone rubber of claim 13 in the form of a tube, hose, gasket, or o-ring.

15. A method of making a silicone rubber comprising curing the addition-cure silicone rubber composition of claim 1.

16. A silicone rubber composition comprising:
(A) an alkenyl-functional siloxane comprising aryl-functional siloxane units; and
(B) a polyhydrogensiloxane;
wherein the silicone rubber composition in the cured state has a softening temperature down to −110° C. using Differential Scanning Calorimetry (DSC); and/or wherein the cured silicone rubber is substantially free of bubbles.

17. The silicone rubber composition of claim 16, wherein the aryl-functional siloxane units in an amount of from about 4.8 mol % to about 13 mol %.

18. The silicone rubber composition of claim 16, further comprising an organohydrogen siloxane (C) having six or fewer siloxane units.

19. The silicone rubber composition of claim 18, wherein the organohydrogen siloxane (C) is present in an amount of from about 0.01 wt. % to about 0.8 wt. % based on the total weight amount of (B) and (C).

20. The silicone rubber composition of claim 16 further comprising a surface modified silica.

21. The silicone rubber composition of claim 20, wherein the surface modified silica comprises silane functional groups.

22. The silicone rubber composition of claim 20 wherein at least three different silylating agents are utilized.

23. The addition-cure silicone rubber composition of claim 22, wherein the surface modified silica is modified with a silane, a siloxane, and a silazane.

24. The addition-cure silicone rubber composition of claim 20, wherein the surface modified silica has at least 40 mol % of surface silanols modified with a functional group.

25. The silicone rubber composition of claim 16, wherein the silicone rubber composition in the cured state has a softening temperature down to −115° C. using DSC.

26. Use of the addition-cure silicone rubber composition of claim 1 for preparing a conduit for a medical application.

27. The use of claim 26, wherein the conduit is a tube.

28. The use of claim 26, wherein the medical application is a pharmaceutical application.

29. The use of claim 28, wherein the pharmaceutical application is for delivery of a medicine, vaccine, cell formulation, or cell bank.

30. Use of the addition-cure silicone rubber composition of claim 1 for preparing an o-ring seal for a gasket.

31. The use of claim 30, wherein the gasket is employed in a component of an aircraft vehicle.
